(19) United States
(12) Patent Application Publication
(10) Pub. No.: US 2017/0200155 A1
(43) Pub. Date: Jul. 13, 2017

(54) GENERATING AND SENDING ENCRYPTED PAYMENT DATA MESSAGES BETWEEN COMPUTING DEVICES TO EFFECT A TRANSFER OF FUNDS

(71) Applicant: MasterCard International Incorporated, Purchase, NY (US)

(72) Inventors: Pablo Fourez, Scarsdale, NY (US); Matthew James Miller, Redding, CT (US)

(21) Appl. No.: 15/403,796

(22) Filed: Jan. 11, 2017

Related U.S. Application Data
(60) Provisional application No. 62/277,143, filed on Jan. 11, 2016.

(51) Int. Cl. G06Q 20/38; G06Q 20/24; G06Q 20/36; G06Q 20/34

(52) U.S. Cl. CPC G06Q 20/3829; G06Q 20/34; G06Q 20/24; G06Q 20/367

(57) ABSTRACT

Encrypted payment data messages are sent via a communication network. A payment data message is generated including a primary account number of the account associated with the sender device and a transaction amount. The payment data message is encrypted with a public key of the receiver device. The payment data message is transmitted to the receiving server via the communication network. The receiving server has a private key of the receiver device corresponding to the public key and a receiving account number for the account associated with the receiver device. A payment authorization is generated by the receiving server for processing by the transaction card payment network based on the primary account number of the account associated with the sender device, the transaction amount, and the receiving account number.

### CROSS-REFERENCE TO RELATED APPLICATION

This application claims the benefit of U.S. Provisional Patent Application No. 62/277,143, filed Jan. 11, 2016, the entirety of which is hereby incorporated by reference.

### FIELD OF THE INVENTION

Exemplary embodiments described herein relate to generating and sending encrypted payment data messages between computing devices to effect a transfer of funds via a transaction card payment network.

### BACKGROUND

Consumers and merchants commonly use transaction cards, e.g., payment cards, for transactions. In a typical transaction, a merchant has a virtual or physical payment terminal that is used to process a transaction involving the consumer and the merchant. It would be desirable to allow consumers to transact with other consumers (i.e., person-to-person) and merchants (i.e., person-to-merchant) without the need for such a terminal.

### SUMMARY

Systems and methods are disclosed for sending encrypted funds transfers messages between participants in a transaction. Specifically, a person (i.e., a “sender”) may attempt to settle a transaction with an individual (i.e., a “recipient” or “receiver”) or a merchant by paying for items, such as goods and/or services, via a person-to-person (“P2P”) or person-to-merchant (“P2M”) payment system. Pursuant to disclosed embodiments, a funds transfer transaction includes receiving, at a sender device, a request to create a payment instruction that authorizes a recipient to debit an account of the sender for a transaction amount, securely transmitting the payment instruction to the recipient, processing the payment instruction to cause a payment authorization request to be transmitted to a payment network, the payment authorization request including information identifying the account of the sender, the recipient, and the transaction amount. Once the authorization request is approved, a gateway associated with the recipient causes an account of the recipient to be credited with the transaction amount. Pursuant to disclosed embodiments, the transaction may be cleared and settled using a standard payment system clearing and settlement process.

Transaction card issuers have adopted a practice referred to as “tokenization,” in which surrogate values (i.e., tokens) replace primary account numbers (PANs) during part of the operation of payment systems. One reason for using tokens in place of PANs is to combat potentially fraudulent activities. Pursuant to disclosed embodiments, the funds transfer may be performed using tokenized payment credentials, such as, for example, tokens issued and managed pursuant to the Payment Token Interoperability Standard (issued by MasterCard International Incorporated, Visa International, and American Express in November 2013, the contents of which are hereby incorporated by reference in their entirety for all purposes) and by senders and recipients operating mobile devices that are “tokenized” or provisioned with a token. In disclosed embodiments, the transactions are performed in an EMV-based payment system enabling secure and guaranteed person-to-person and person-to-merchant payments.

One aspect of the disclosed embodiments relates to a method of generating and sending encrypted payment data messages between a sender device and a receiving server via a communication network to effect a transfer of funds via a transaction card payment network between an account associated with the sender device and an account associated with the receiver device. The sender device, the receiver device, and the receiving server each have a processor and a communication network interface. The method includes generating at the sender device a payment data message including a primary account number, in tokenized form, of the account associated with the sender device and a transaction amount. The payment data message is encrypted with a public key of the receiver device. The method further includes transmitting the payment data message to the receiving server via the communication network interfaces of at least the sender device and the receiving server. The receiving server has a private key of the receiver device corresponding to the public key and a receiving account number for the account associated with the receiver device. The method further includes generating, by the receiving server, a payment authorization for processing by the transaction card payment network based at least in part on the primary account number, in detokenized form, of the account associated with the sender device, the transaction amount, and the receiving account number. The method further includes receiving the payment authorization at the transaction card payment network.

Another aspect of the disclosed embodiments relates to a receiving server for receiving payment data messages generated by a sender device via a communication network to effect a transfer of funds via a transaction card payment network between an account associated with the sender device and an account associated with a receiver device.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings.

FIG. 1 is a block diagram of a system for generating and sending encrypted payment data messages between computing devices to effect a transfer of funds according to embodiments disclosed herein;

FIG. 2 is a block diagram of a system for pairing a receiver device and a sender device so encrypted payment data messages can be sent therebetween;

FIG. 3 is a block diagram of a system for generating and sending tokenized, encrypted payment data messages between computing devices to effect a transfer of funds via a transaction card network;

FIGS. 4A and 4B depict a method for generating and sending encrypted payment data messages between computing devices to effect a transfer of funds via an existing payment network;

FIG. 5 depicts a method for generating and sending encrypted payment data messages between a sender device and a receiving server via a communication network to effect a transfer of funds via a transaction card payment network;

FIGS. 6A and 6B depict a message flow for generating and sending encrypted payment data messages between a sender device and a receiving server via a communication network to effect a transfer of funds via a transaction card payment network; and

FIG. 7 is a block diagram showing a structure of an electronic device for facilitating the generation and sending of encrypted payment data messages between computing devices to effect a transfer of funds, in accordance with disclosed embodiments.

### DETAILED DESCRIPTION

The term “tokenize” and/or “tokenization,” as used herein, refers to providing a token or Token Number that is associated with a consumer's primary account number (PAN) by a token service provider (TSP). In addition, the terms “transaction card network,” “payment card network” and “payment network,” as used herein, refer to a payment network or payment card network or payment system operated by a payment processing entity, such as MasterCard International Incorporated, or other networks which process payment transactions on behalf of a number of merchants, issuers and payment account holders (i.e., holders of transaction card accounts, such as credit card account and/or debit card account and/or loyalty card account holders, commonly referred to as cardholders or payment account holders). As used herein, the term “sender” refers to a participant to a transaction that will have an associated account debited in a transaction amount. As used herein, the term “recipient” refers to a participant to a transaction that will have an associated account credited in the transaction amount. A “sender” or a “recipient” (or both) may be consumers operating devices configured to operate pursuant to the present invention, or one or both may be merchants operating devices configured to operate pursuant to the present invention. Pursuant to disclosed embodiments the “devices” operated by the sender and recipient may be mobile devices (such as mobile phones, tablets or the like).

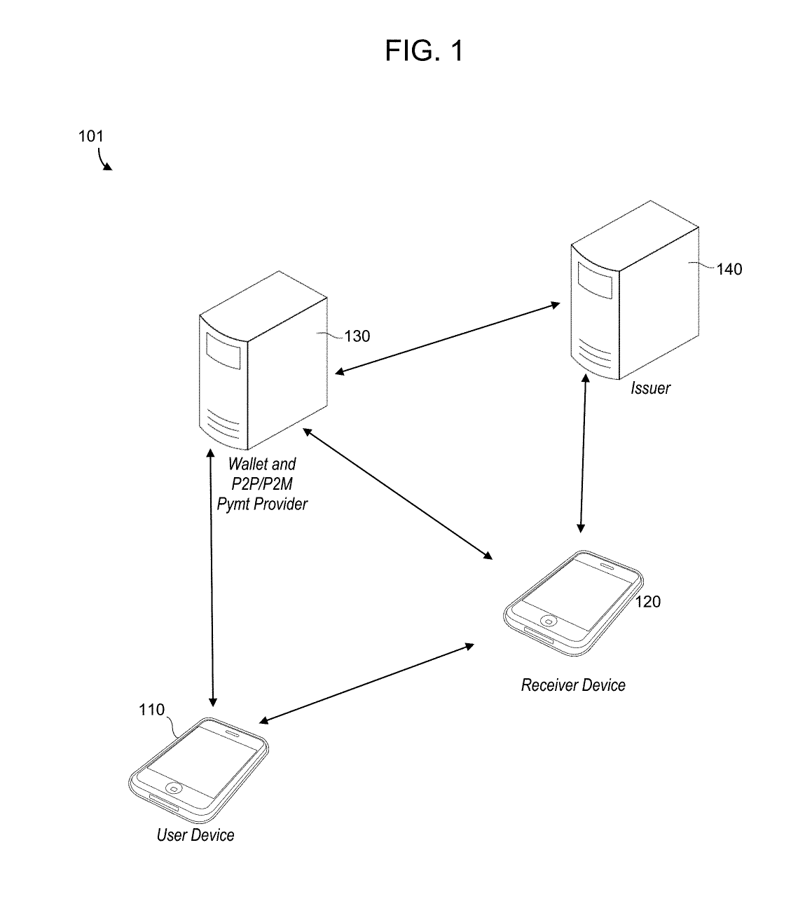

FIG. 1 depicts a system 101 generating and sending encrypted payment data messages between computing devices to effect a transfer of funds in accordance with disclosed embodiments. The system 101 includes a user device 110 (i.e., sender device), a receiver device 120, a wallet and P2P/P2M payment server 130, i.e., a digital wallet and person-to-person (“P2P”) or person-to-merchant (“P2M”) payment server, and an issuer 140. It should also be appreciated that additional devices not shown may be included in the system 101 such as a payment gateway, an acquirer, and any other devices. The devices within the system 101 may connect to one another via a wired or wireless connection through a network (e.g., Internet, private network, etc.), direction connection, and the like. Furthermore, in disclosed embodiments, the digital wallet and the P2P/P2M payment servers may be implemented as separate and/or multiple servers.

The user device 110 may be any device capable of using a digital wallet, such as, for example, a mobile device, a computer, a laptop, a tablet, a mobile phone, a kiosk, an appliance, etc. The user device 110 may have a digital wallet installed therein that is hosted by the wallet provider (e.g., on a wallet provider server 130). The digital wallet may include at least one payment account therein (e.g., credit card, debit card, check card, etc.) that is issued by an issuer (e.g., on an issuer server 140) which may correspond to a bank, a credit agency, or other type of financial institution. Examples of a digital wallet include MasterCard MasterPass, Apple Pay, Google Wallet, and many others. Digital wallets can be used in-store and online and typically require authentication/authorization of the digital wallet user at the time of purchase such as, for example, a username, password, and PIN. During enrollment, digital wallets require a user to provide sensitive information such as personal information, contact information, financial information, etc.

The disclosed embodiments may be implemented via a particular app on the user device 110 or via the digital wallet on the user device 110. According to various aspects, a person (i.e., a “sender”) having the user device 110 may attempt to settle a transaction with an individual (i.e., a “recipient” or “receiver”) or a merchant by paying for items, such as goods and/or services, via a person-to-person (“P2P”) or person-to-merchant (“P2M”) payment system. In disclosed embodiments, the P2P/P2M payment system uses the payment account issued by issuer 140 and associated with a digital wallet provided by wallet provider 130 but other types of payment accounts associated with other issuers may also be used. For example, the user device 110 may be a mobile phone attempting to make payment in-store, without the use of a point-of-sale (POS) terminal, or online through a merchant website. Alternatively, the user device 110 may be used to make a payment directly to an individual, i.e., a P2P payment, via a receiver device 120, which may be a mobile device, a computer, a laptop, a tablet, a mobile phone, a kiosk, an appliance, etc.

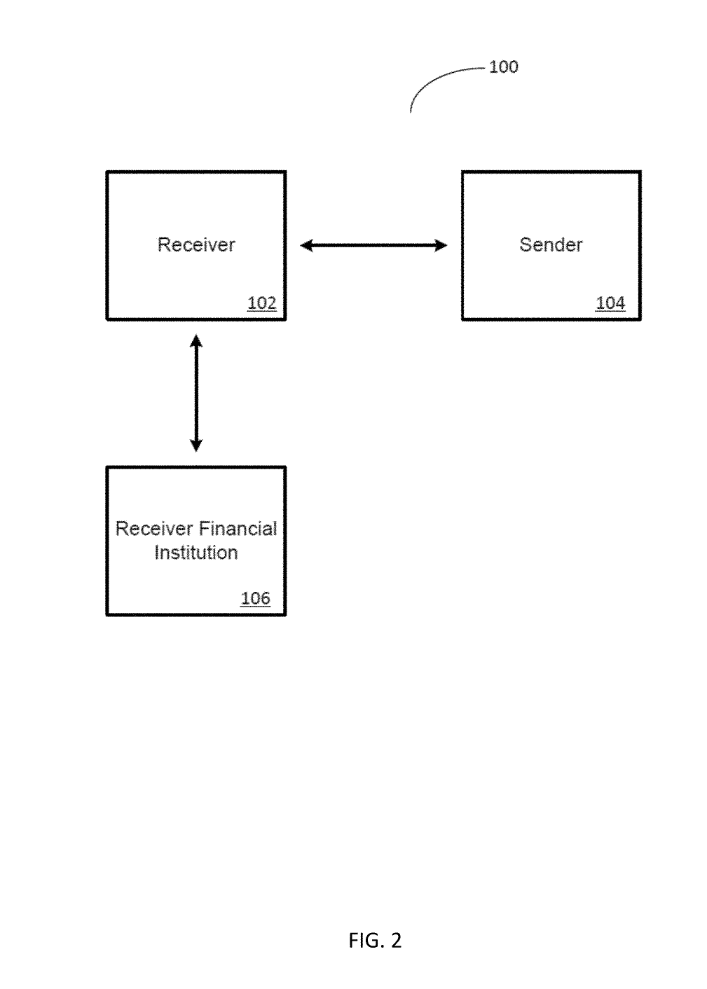

FIG. 2 depicts a system 100 for pairing a receiver device and a sender device so encrypted payment data messages can be sent therebetween to initiate a P2P/P2M transaction pursuant to disclosed embodiments. As shown, the system 100 includes a receiver 102 (i.e., a receiver device), a sender 104 (i.e., a sender device) and a receiving financial institution 106 (i.e., a receiving server). Pursuant to disclosed embodiments, the receiver 102 and the sender 104 are devices configured to operate pursuant to a transaction card payment system. For example, the devices may be mobile devices configured with payment applications allowing the mobile devices to conduct payment transactions in accordance with the EMV standards.

To initiate a transaction, the receiver 102 and the sender 104 may conduct a “pairing” process. In disclosed embodiments, the pairing process may be initiated by either the sender or the receiver and results in the receiver 102 providing a stored public key to the sender 104. In disclosed embodiments, the receiver 102 obtains the public key from a financial institution (or agent thereof) such as the receiver financial institution 106. The receiver financial institution 106 may generate or create a unique public/private key for each participating cardholder (such as receiver 102). In one example of a pairing process, receiver 102 may share the public key with one or more potential sender(s) 104 by transmitting a message to the potential sender(s) 104 via email or other messaging. Once the sender 104 has the public key of the recipient 102, the sender 104 may initiate a transfer process pursuant to the present invention.

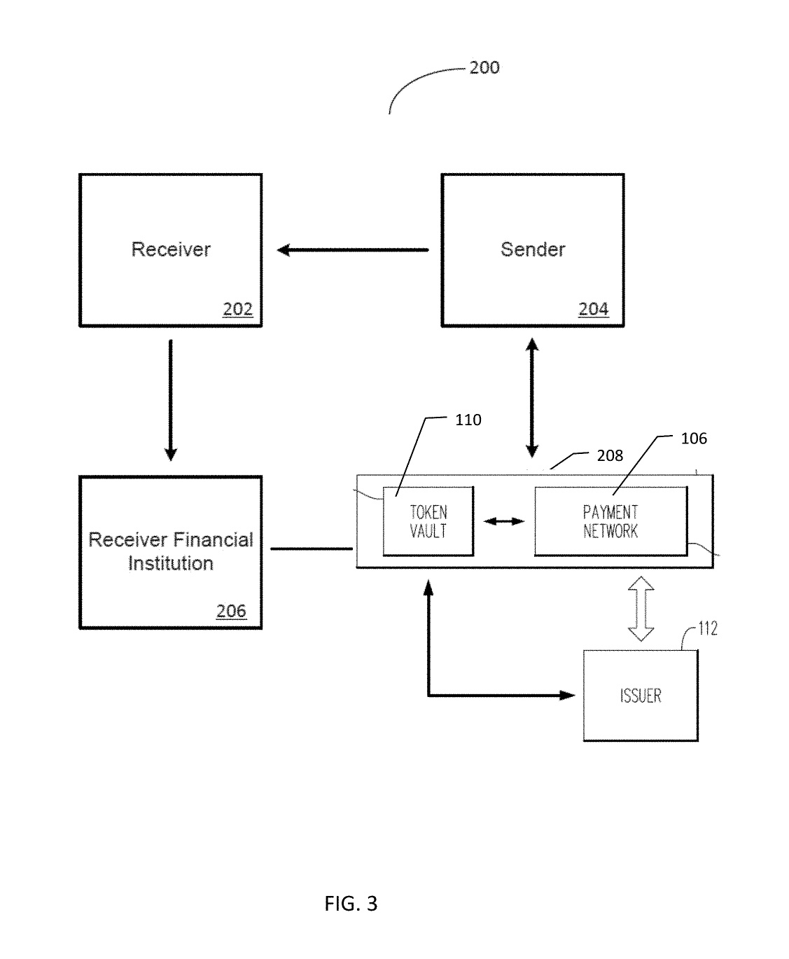

FIG. 3 shows a block diagram of a portion of a system 200 for performing a P2P/P2M transfer transaction pursuant to disclosed embodiments (it is assumed that the pairing process described above has already been performed between the sender 204 and the receiver 202). The system 200 includes a receiver 202, a sender 204 and a receiving financial institution 206 and further includes a tokenization service 208 (i.e., token service provider). The tokenization service 208 may be, for example, the MasterCard Digital Enablement Service (“MDES”) provided by MasterCard International Incorporated.

The token service provider 208 may in disclosed embodiments also be the operator of a payment network 106, such as that operated by MasterCard International Incorporated. The token service provider 208 may be authorized in the payment system to issue tokens to token requestors. In issuing tokens, the token service provider 208 may perform such functions as operating and maintaining a token vault 110, generating and issuing tokens, assuring security and proper controls, token provisioning (e.g., personalizing payment cards, etc. with token values), and registering token requestors. In disclosed embodiments, some or all of the functions of the token service provider 208 may be taken on by a payment card issuer 112 (e.g., issuer 140 in FIG. 1).

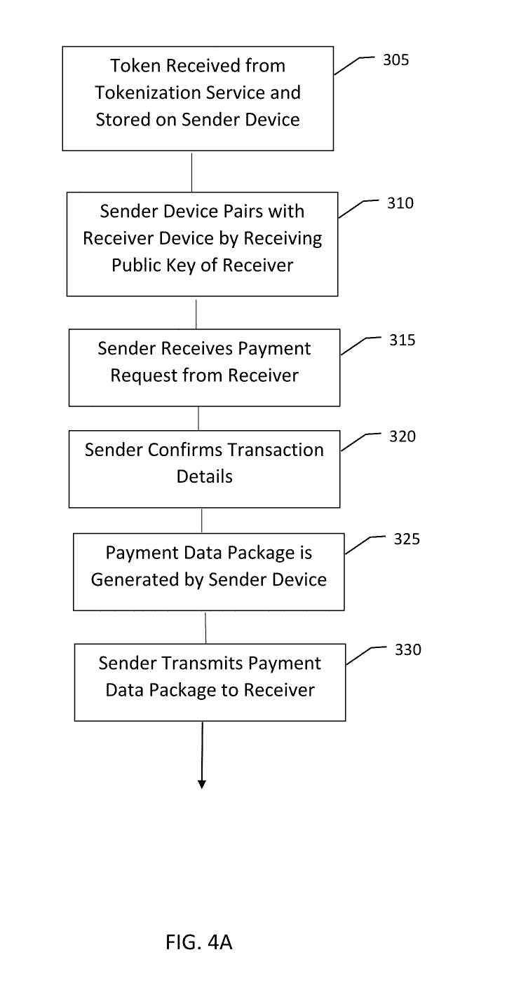

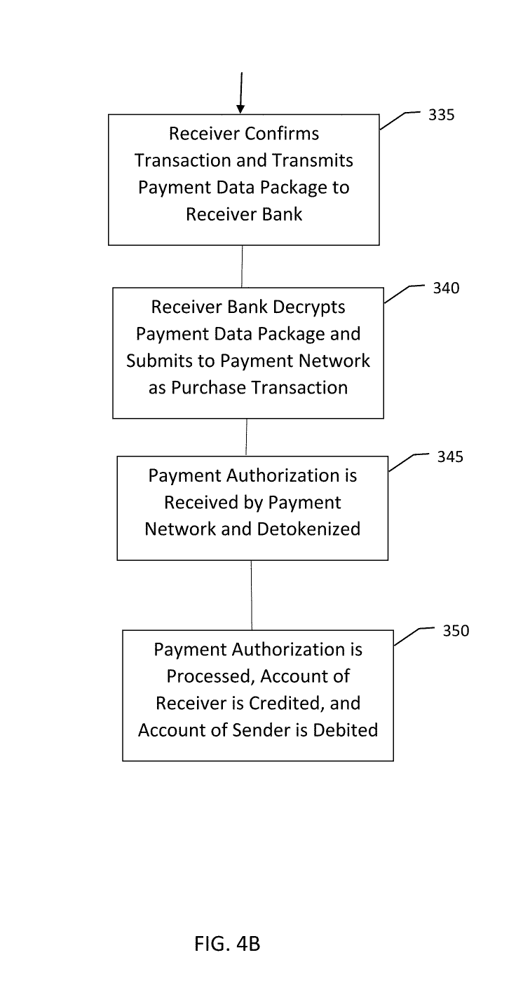

FIGS. 4A and 4B depict a method for generating and sending encrypted payment data messages between computing devices to effect a transfer of funds via an existing payment network. In disclosed embodiments, the funds transfer process may use the system 200 described above (see FIG. 3) and may proceed as follows. The sender 204 interacts with the tokenization service 208 to obtain a token which is a representation or proxy associated with a payment account associated with the sender 204 (Step 305). In disclosed embodiments, the token is a digital secure remote payments (DSRP) compatible token such as those issued by the MDES service. The token may be stored in a secure element or secure area of the sender device 204.

The sender device 204 pairs with the receiver device 202 (Step 310), as described above. The sender device 204 may receive a request from the receiver device 202 to pay the recipient (Step 315). The request includes, among other things, a transaction amount. The user of the sender device 204 interacts with a user interface, such as, for example, the user interface of a wallet application on the device, to confirm (or enter) the transaction amount and other transaction details (Step 320). The wallet application (or other application on sender device 204) creates a payment data package (i.e., payment instruction) containing data that authorizes the recipient to debit a payment account of the sender for the transaction amount (Step 325). The payment package is encrypted using the unique public key of the receiver 202 which was received during the pairing process. In disclosed embodiments, the encrypted payment package includes data such as: the name of the recipient, a name or identifier of the receiver device 202, the transaction amount, the token, an expiration date associated with the token, and a cryptogram (e.g., a DSRP cryptogram). The use of a cryptogram (e.g., as specified by the EMV standards) results in the transaction amount being bound to the cryptogram.

The sender 204 transmits or provides the encrypted payment package to the receiver 202 (Step 330), e.g., by communicating via email, instant message, SMS, by presenting a QR code, Bluetooth, etc. The receiver 202 receives the encrypted payment data package, confirms the transaction, and transmits the encrypted payment data package to the receiving financial institution 206 associated with receiver 202 (Step 335). The receiving financial institution 206 decrypts the payment package with the private key that corresponds to the receiver's public key and processes the transaction as a standard purchase transaction on a payment network (Step 340). For example, the receiver bank 206 may generate a standard payment authorization request for transmission to a payment network such as the BankNet network operated by MasterCard International Incorporated. The merchant details portion of the authorization request is populated with a unique payment ID for the transaction and the name of the receiver. The payment authorization request is routed to the tokenization service 208 based on the token routing information where it is processed as a normal tokenized payment transaction, including “detokenization,” in which the token is to identify the actual payment credentials associated with the sender's payment account (Step 345). The transaction is then completed as a normal payment transaction, resulting in the account of the receiver being credited with the transaction amount and the account of the sender being debited by that amount (or an amount plus a transaction fee in disclosed embodiments) (Step 350).

The result is a secure and efficient transaction process. The use of the dual encryption ensures that the sender purchase cannot be altered because the transaction amount is in the cryptogram and thus it cannot be intercepted by an alternative receiver because the payment package is encrypted using the receiver's unique public key. Further, financial institutions can provide person-to-person and person-to-merchant transactions at virtually no cost using existing payment networks.

The following is a description of an embodiment for processing of a P2P/P2M transaction in a specific implementation using MasterCard systems, but other similar payment systems may also be used. To carry out a payment instruction, the sender uses a payment application, e.g., a digital wallet or a related standalone app, to create a payment instruction that authorizes the recipient to debit the sender's account for a transaction amount. The payment application may be tokenized following MasterCard's MCBP specifications. The system may use specific payment keys for P2P/P2M payments to segregate risk from point-of-sale (POS) payments. The payment application generates an EMV payment cryptogram for the transaction amount following cardholder authentication, which provides proof that the sender authorized the sender's account to be debited for the transaction amount.

In this embodiment, there is a transfer of payment instructions to recipient in which the sender sends the payment instruction (i.e. the payment token and the cryptogram) to the recipient. The payment instruction should only be usable by the intended recipient. This may be achieved in different ways. For example, the payment instruction could be encrypted for transmission by the sender using a public key previously shared by the recipient, as discussed above. A way to implement this key sharing would be for the sender and the receiver to “pair” prior to the money transfer being initiated. This pairing may be done in proximity by pairing both devices via, e.g., NFC, Bluetooth, etc. or remotely via an in-app message, email, etc. Some remote methods of pairing may utilize a directory service to connect the sender and the receiver.

In this embodiment, there is a processing of transactions in which the recipient gateway submits an EMV DSRP transaction for authorization through the MasterCard network via the recipient's acquiring bank, using the token and cryptogram provided by the sender. If the recipient is a consumer, the name of the consumer will be provided so it appears on the card statement. For example: “MoneySend * Consumer Name”. If the recipient is a merchant, the name of the merchant will be provided. Upon successful authorization, the gateway will instruct the bank of the recipient to credit the funds on the recipient's card account. In disclosed embodiments, if the issuing bank of the card of the recipient is different from the bank acquiring the purchase transaction, the recipient's gateway may deposit funds via a “MoneySend” transaction into the recipient's account. Preferably, the issuing bank of the recipient would make funds available within a specific period of time, e.g., 30 minutes, of the transaction being authorized.

In this embodiment, there is a settlement of funds in which the acquiring bank submits the funding transaction for clearing through the MasterCard network. The acquiring bank may be assessed an interchange for every funding transaction. This would allow for the issuing bank to be remunerated for each transaction regardless of whether it is P2P or P2M.

In disclosed embodiments, there may be disputes and chargebacks, which means that an entity, such as MasterCard, will define rules to classify recipients as either consumers or as a business. Any recipient with a cumulative transaction count greater than, e.g., 100 transactions, and a cumulative dollar amount greater than, e.g., $1000 in a given month, may be considered a business. In disclosed embodiments, such thresholds may be defined on a country-by-country basis.

In disclosed embodiments, the recipient's wallet may facilitate payments for small businesses under, e.g., $100K per year. Above this threshold, each business must enter into a direct acquiring relationship in order to participate in the transaction process of the present invention.

Consumer-to-consumer payments (i.e., P2P) in disclosed embodiments cannot be repudiated and no charge backs are allowed. In disclosed embodiments, MasterCard will not allow recurring payments for P2P payments because, for example, all consumer payments may require a cryptogram.

Consumer to business payments (i.e., P2M) through the transaction system may be subject to charge back rights pursuant to the MasterCard rules, but because the purchase is issuer-verified (e.g., a DSRP cryptogram generated by the issuer), the business benefits from a liability shift for fraud, and the issuer of the sender cannot charge back for “did not authorize.” To differentiate between consumer payments and business payments, different merchant category codes (MCC) may be used. An entity, such as MasterCard, may define one MCC for consumer payments and one MCC for small business payments. In disclosed embodiments, existing MCCs could be used for merchant payments.

The disclosed embodiments provide a number of advantages over conventional payment processing methods. For example, an efficient way is provided for consumers to conduct payments that can be controlled and distributed by card issuers to consumers. Furthermore, existing payment card processing systems are used so that: (i) P2P transactions are revenue bearing for the originating issuer; and (ii) P2M transactions do not impact existing transaction types available at the point of sale. By using appropriate standards, the interoperability of money transfers between payment card systems is provided.

The disclosed embodiments provide a funds transfer system that is secure, using best-in-class payment technology including EMV, tokenization, cryptography, etc., so that: (i) payments made through the system are secure; (ii) associated transactions have full end-to-end transparency, traceability, and legitimacy in accordance with applicable anti-money laundering, “know your customer” (KYC), and other money transfer requirements; and (iii) P2P transactions cannot be repudiated (i.e., they are as good as cash) while also allowing for efficient charge-back processes necessary for P2M payments (e.g. disputes, non-delivery of services, etc.).

Pursuant to disclosed embodiments, sensitive consumer information associated with senders and receivers (e.g., consumer names, email addresses, phone numbers, and payment account numbers) are distributed across different participating financial institutions and consumer devices, thereby providing improved privacy and security of that information. Pursuant to disclosed embodiments, recipients (e.g., consumers) can use received funds to make guaranteed point-of-sale or in-app purchases at merchants, providing compatibility across payment schemes.

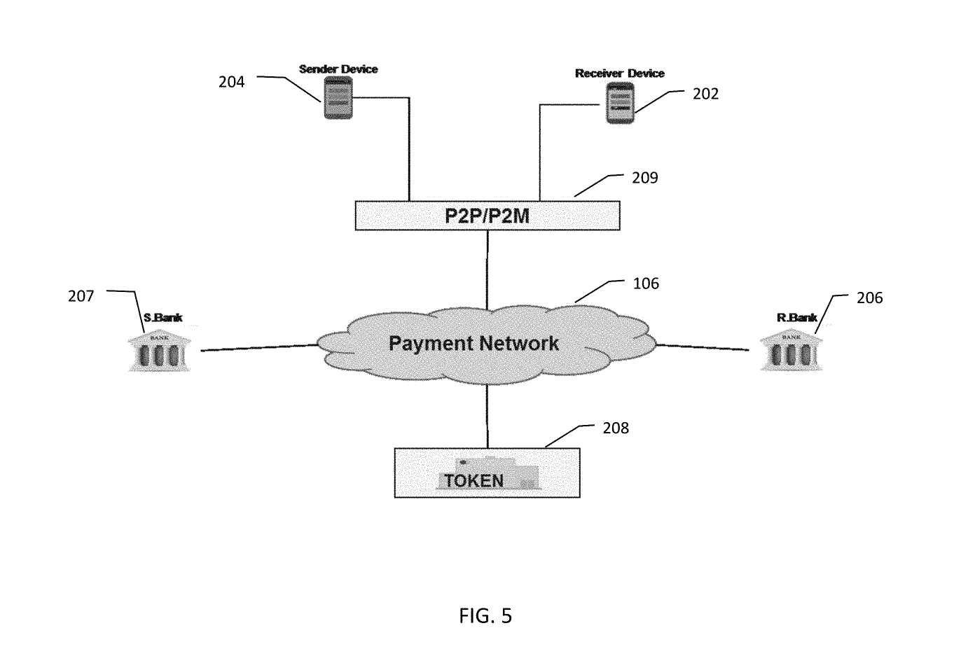

FIG. 5 depicts a system for generating and sending encrypted payment data messages between a sender device and a receiving server via a communication network to effect a transfer of funds via a transaction card payment network. In this embodiment, as above, the sender device 204 pairs with the receiver device 202. The sender device 204 may receive a request from the receiver device 202 to pay the recipient. The user of the sender device 204 interacts with a user interface, such as, for example, the user interface of a wallet application on the device, to confirm (or enter) the transaction amount and other transaction details. The wallet application (or other application on sender device 204) creates a payment data package (i.e., payment instruction) containing data that authorizes the recipient to debit a payment account of the sender for the transaction amount. The payment package is encrypted using the unique public key of the receiver 202 which was received during the pairing process

In this embodiment, the sender 204 transmits or provides the encrypted payment package to a payments server, e.g., a P2P/P2M server 209, without having the payment package pass through the receiver 202, e.g., by communicating via email, instant message, SMS, by presenting a QR code, Bluetooth, etc., or by using a user interface on a website, a digital wallet, or other application on the sender device 204. The P2P/P2M server 209 receives the encrypted payment data package and decrypts it with the private key that corresponds to the receiver's public key. The P2P/P2M server 209 then processes the transaction as a standard purchase transaction on a payment network 106. For example, the P2P/P2M server 209 may generate a standard payment authorization request for transmission to a payment network 106 such as the BankNet network operated by MasterCard International Incorporated. The merchant details portion of the authorization request is populated with a unique payment ID for the transaction and the name of the receiver. The payment authorization request is routed to the tokenization service 208 based on the token routing information where it is processed as a normal tokenized payment transaction, including “detokenization,” in which the token is to identify the actual payment credentials associated with the sender's payment account. The transaction is then completed as a normal payment transaction, resulting in the account of the receiver being credited with the transaction amount and the account of the sender being debited by that amount (or an amount plus a transaction fee in disclosed embodiments).

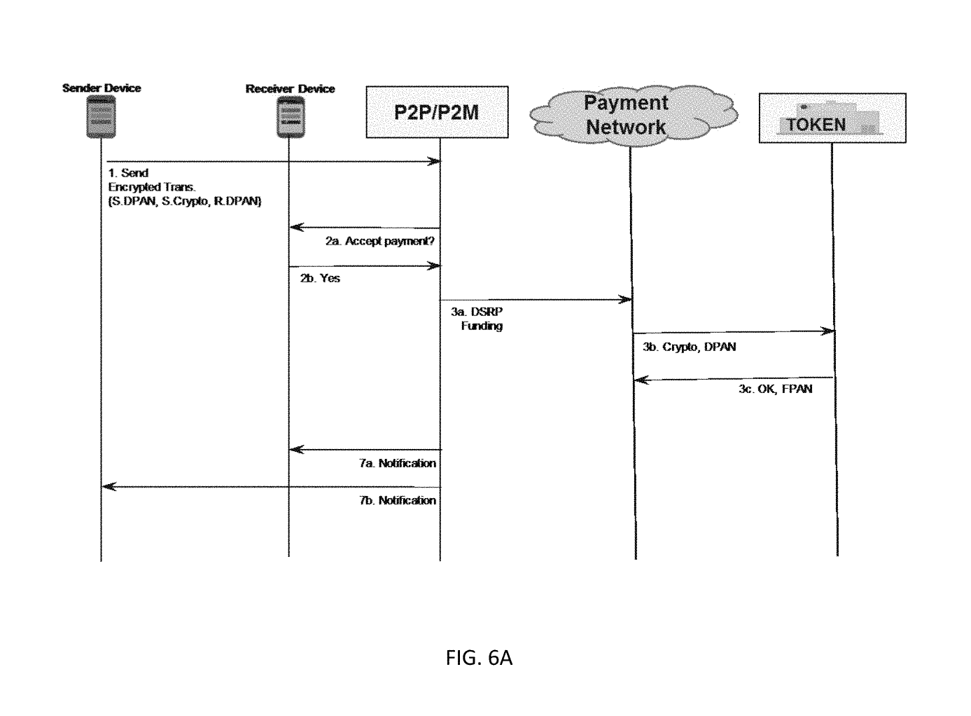

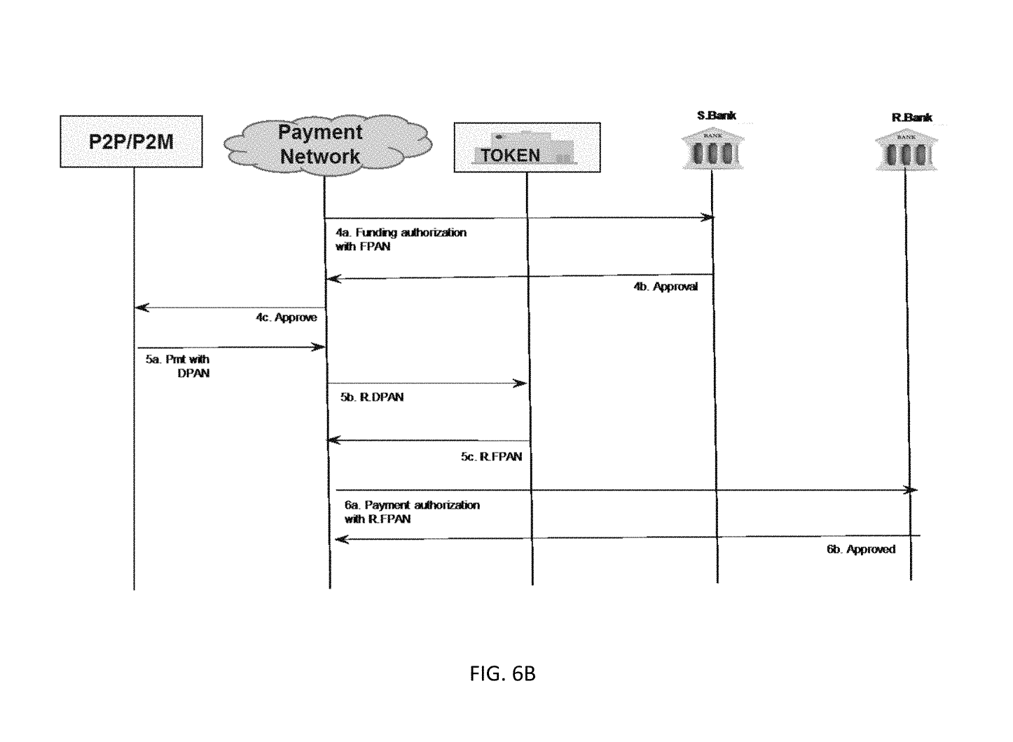

FIGS. 6A and 6B depict a message flow for generating and sending encrypted payment data messages between a sender device and a receiving server via a communication network to effect a transfer of funds via a transaction card payment network. As shown in FIG. 6A, the sender device sends an encrypted transaction to the P2P/P2M server (Step 1) which includes the senders tokenized primary account number (S.DPAN), a cryptographic element generated by the sender (S.Crypto), and the tokenized primary account number of the receiver (R.DPAN). The receiver device receives and acknowledges an acceptance message (Steps 2a and 2b). The P2P/P2M server sends a funding authorization, e.g., a funding authorization in accordance with digital secure remote payments (DSRP) (Step 3a). The payment network sends the cryptographic element and the tokenized primary account number (DPAN) to a tokenization service to detokenize the PAN of the sender (Step 3b). The tokenization service returns the sender's PAN (Step 3c).

As shown in FIG. 6B, the payment network sends a funding authorization with the sender's detokenized PAN to the sender's bank (Step 4a) and receives an approval (Step 4b). The payment network returns an approval indication to the P2P/P2M server (Step 4c). The P2P/P2M server sends a payment authorization using the sender's tokenized PAN (Step 5a). The payment network detokenizes the payment authorization (Steps 5b and 5c) and sends the payment authorization to the receiver's bank (Step 6a) and receives an approval (Step 6b). Referring again to FIG. 6A, notifications may then be sent to the receiver device (Step 7a) and sender device (7b).

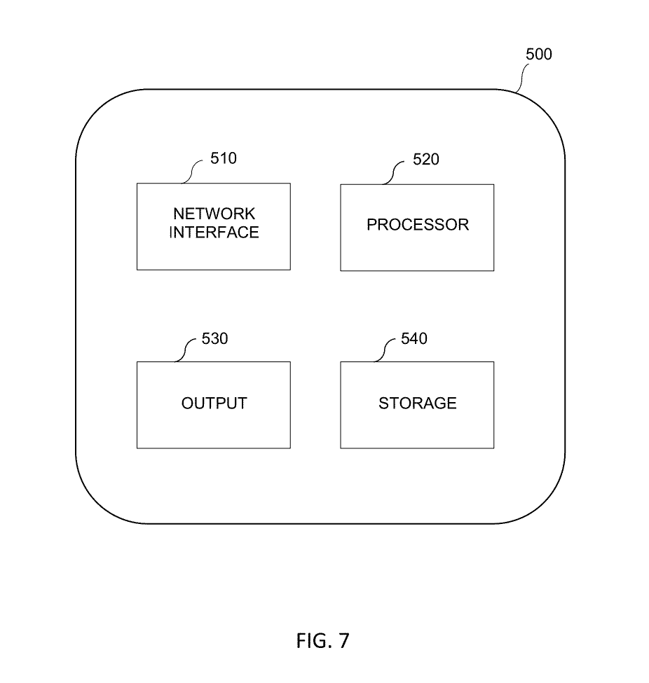

FIG. 7 is a block diagram of a structure of an electronic device 500 for facilitating the generation and sending of encrypted payment data messages between computing devices to effect a transfer of funds via a transaction card payment network, in accordance with disclosed embodiments. For example, the structure of this device 500 may be used for the wallet and P2P/P2M payment providing server 130 of FIG. 1, or other devices disclosed herein which carry out software instructions. The device 500 includes a network interface 510, a processor 520, an output 530, and a storage device 540. The device 500 may include other components such as a display, an input unit, a receiver/transmitter, and the like. Also, the network interface 510 may also be referred to as a transmitter, a receiver, a transmitter, and/or the like. The network interface 510 may transmit and receive data over a network such as the Internet, a private network, a public network, etc. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like. According to various embodiments, the storage 540 may store data about existing digital wallet users, for example, sensitive information such as personal information, contact information, employment information, credit information, and the like.

As used herein and in the appended claims, the terms “transaction card account” and “payment card account” include a credit card account, a deposit account that the account holder may access using a debit card, a prepaid card account, or any other type of account from which payment transactions may be consummated. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein, the term “account” may refer to a card, transaction card, financial transaction card, payment card, and the like, refer to any suitable transaction card, such as a credit card, a debit card, a prepaid card, a charge card, a membership card, a promotional card, a frequent flyer card, an identification card, a gift card, and the like, and also refer to any suitable payment account such as a deposit account, bank account, credit account, and the like. As another example, the terms may refer to any other device or media that may hold payment account information, such as mobile phones, Smartphones, key fobs, computers, and the like. The transaction card can be used as a method of payment for performing a transaction.

As will be appreciated based on the foregoing specification, the above-described examples of the disclosure may be implemented using computer programming or engineering techniques including computer software, firmware, hardware or any combination or subset thereof. The computer programs (also referred to as programs, software, software applications, “apps”, or code) may include machine instructions for a programmable processor, and may be implemented in a high-level procedural and/or object-oriented programming language, and/or in assembly/machine language.

The above descriptions and illustrations of processes herein should not be considered to imply a fixed order for performing the process steps. Rather, the process steps may be performed in any order that is practicable, including simultaneous performance of at least some steps.

Although the present disclosure has been described in connection with specific exemplary embodiments, it should be understood that various changes, substitutions, and alterations can be made to the disclosed embodiments without departing from the spirit and scope of the disclosure as set forth in the appended claims.

What is claimed is:

1. A method of generating and sending encrypted payment data messages between a sender device and a receiving server via a communication network to effect a transfer of funds via a transaction card payment network between an account associated with the sender device and an account associated with a receiver device, wherein the sender device, the receiver device, and the receiving server each having a processor and a communication network interface, the method comprising:
generating at the sender device a payment data message comprising a primary account number, in tokenized form, of the account associated with the sender device and a transaction amount, the payment data message being encrypted with a public key of the receiver device;
transmitting the payment data message to the receiving server via the communication network interfaces of at least the sender device and the receiving server, the receiving server having a private key of the receiver device corresponding to the public key and a receiving account number for the account associated with the receiver device;
generating, by the receiving server, a payment authorization for processing by the transaction card payment network based at least in part on the primary account number, in detokenized form, of the account associated with the sender device, the transaction amount, and the receiving account number; and
receiving the payment authorization at the transaction card payment network.

2. The method of claim 1, wherein the payment authorization results in a debit to the account associated with the sender device and a credit to the account associated with the receiver device.

3. The method of claim 1, wherein the transmitting of the payment data message comprises sending the payment data message to the receiver device and forwarding the payment data message from the receiver device to the receiving server.

4. The method of claim 3, wherein the receiving server is operated by a financial institution which provides the account associated with the receiver device.

5. The method of claim 1, wherein the transmitting of the payment data message comprises sending the payment data message to the receiving server without passing through the receiver device.

6. The method of claim 1, further comprising receiving at the sender device, via the communication network interface of the sender device, a public key of the receiver device prior to the generating of the payment data message.

7. The method of claim 1, further comprising receiving at the sender device, via the communication network interface of the sender device, a payment request from the receiver device.

8. The method of claim 1, wherein the primary account number is stored on the sender device by a digital wallet.

9. The method of claim 1, wherein the generating of the payment authorization comprises adding a transaction description which includes a recipient name associated with the receiver device.

10. A receiving server for receiving payment data messages generated by a sender device via a communication network to effect a transfer of funds via a transaction card payment network between an account associated with the sender device and an account associated with a receiver device, the receiving server comprising:
a processor, storage, and a communication network interface, the storage comprising a private key of the receiver device corresponding to a public key of the receiver device and a receiving account number for the account associated with the receiver device,
wherein the processor is configured to execute code to perform:
receiving a payment data message, generated by the sender device, via the communication network interface, wherein the payment data message comprises a primary account number, in tokenized form, of the account associated with the sender device and a transaction amount, the payment data message being encrypted with the public key of the receiver device;
generating a payment authorization for processing by the transaction card payment network based at least in part on the primary account number, in detokenized form, of the account associated with the sender device, the transaction amount, and the receiving account number; and
transmitting the payment authorization to the transaction card payment network.

11. The receiving server of claim 10, wherein the payment authorization results in a debit to the account associated with the sender device and a credit to the account associated with the receiver device.

12. The receiving server of claim 10, wherein the payment data message is received from the sender device and passes through the receiver device.

13. The receiving server of claim 12, wherein the receiving server is operated by a financial institution which provides the account associated with the receiver device.

14. The receiving server of claim 10, wherein the payment data message is received from the sender device without passing through the receiver device.

15. The receiving server of claim 10, wherein the generating of the payment authorization comprises adding a transaction description which includes a recipient name associated with the receiver device.
